(19) United States
(12) Patent Application Publication
(10) Pub. No.: US 2006/0026035 A1
(43) Pub. Date: Feb. 2, 2006

(54) Computer aided interactive medical management information and control system and method

(76) Inventors: William Younkes, Greenwood Village, CO (US); Scott Z. Barnes, Thornville, OH (US); Sandra Schreiber, Castle Rock, CO (US); Dave Earle Wilson, Castle Rock, CO (US)

Correspondence Address: PETER F WEINBERG;GIBSON DUNN AND CRUTCHER LLP, SUITE 4100, 1801 CALIFORNIA STREET, DENVER, CO, 80202, US

(21) Appl. No.: 10/901,364

(22) Filed: Jul. 28, 2004

(51) Int. Cl. G06Q 10/00; G06G 7/48

(52) U.S. Cl. 705/2; 703/11

(57) ABSTRACT

A computer aided interactive medical management information and control system and method includes one or more devices and a computing platform and associated software that assists the health care provider in performing a treatment on a patient. Output information of equipment relevant to performing the treatment is integrated with reference databases of best demonstrated practices, similar cases, industry guidelines, and procedure and equipment trouble shooting. The present invention can also serve as a remote control for networked medical equipment and provide data for the patient record. The health care provider is able to immediately access emergency procedures and/or be voice and/or video linked to other institutions and personnel for consultation while performing the treatment. Diagnostic systems information may be combined with current patient information and analyzed to provide real time guidance and alerts for adverse events, and provide references for managing critical stages of the treatment.

### FIELD OF THE INVENTION

This invention relates to medical management information and control systems, and more particularly, to a computer aided interactive medical management information and control system and method for assessing, diagnosing, planning, and/or performing treatment on a patient by a health care provider.

### BRIEF DESCRIPTION OF THE DRAWINGS

FIG. 1 shows a schematic/block diagram of an embodiment of a computer aided interactive medical management information and control system of the present invention.

FIG. 2 shows a schematic/block diagram of the computing platform of FIG. 1 in an embodiment of the present invention.

FIGS. 3A and 3B show a block flow diagram of an embodiment of a computer aided interactive medical management information and control method for assessing, diagnosing, planning, and/or performing treatment on a patient by a health care provider of the present invention.

### DETAILED DESCRIPTION OF THE INVENTION

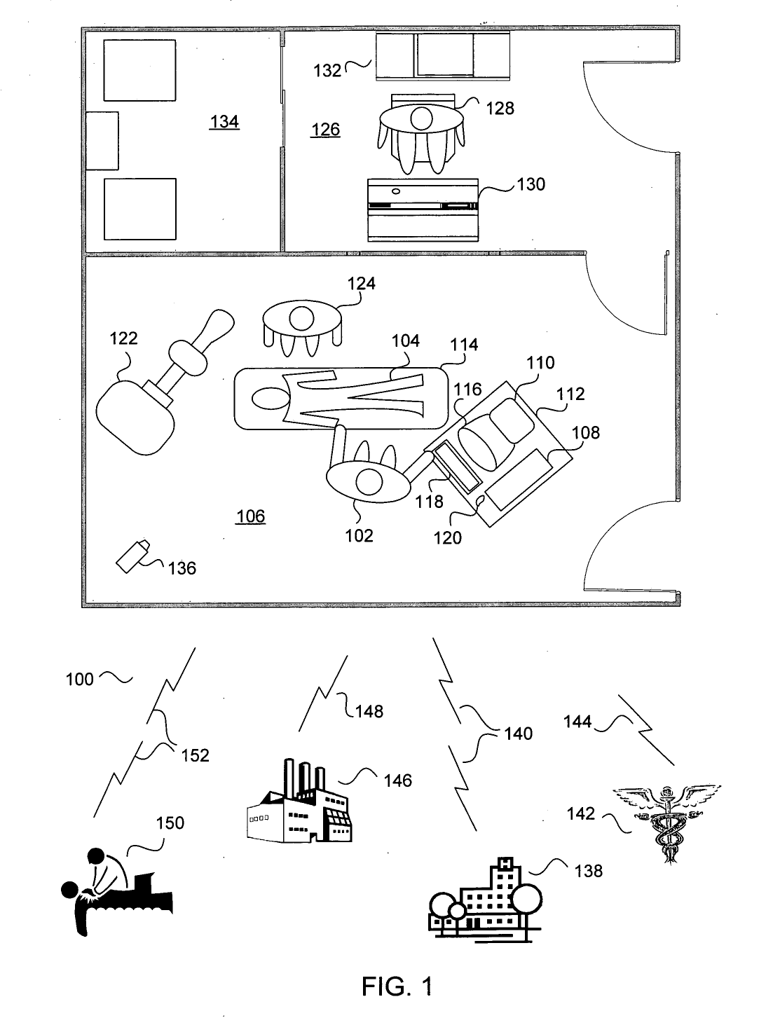

Referring now to the Figures, in which like reference numerals refer to like components thereof, FIG. 1 shows a schematic/block diagram of an embodiment of a computer aided interactive medical management information and control system of the present invention. Today's health care providers have a plethora of new surgical tools, diagnostic aids, medical devices, and pharmaceutical agents at their disposal that allow them to provide the latest treatments to their patients. The rate of evolution of these new options provides an overwhelming challenge for individual health care providers to learn new skills and maintain competency. The term “health care provider” as used herein is intended to be broad in scope and may include by way of example, but is not limited to, doctors (including surgeons, physicians, anesthesiologists, etc.), health care provider's assistants, nurses and nurse practitioners, physical and occupational therapists, respiratory therapists, medical device manufacturer representatives, and the like. The term “treatment” as used herein is intended to be broad in scope and may include by way of example, but is not limited to, surgical procedures of all types, anesthesiology procedures, chiropractic treatment, diagnostic procedures, physical therapy treatments, and the like.

Health care providers spend significant amounts of time outside of seeing their patients to learn how to use new tools, and reviewing relevant cases to their practice in assessing, diagnosing, planning, and/or preparing for performing a treatment for their patients. However, once in the surgical or diagnostic suite, or other facility or location where the treatment is to be performed, the health care provider is largely left to relying on his or her own memory to effectively use the many tools at his or her disposal during the treatment. The health care provider may often encounter unexpected developments or complications during the treatment that may not have been anticipated prior to beginning the treatment. Unfortunately, the health care provider is often in a situation where he or she cannot stop the treatment to review other data, recall references, or perform analysis or simulations that could aid the health care provider in successfully completing the treatment.

The system and method of the present invention includes one or more devices and a computing platform consisting of a single computer or multiple linked computers or computer processors and associated software, which may be used together or singly, that assists the health care provider within the diagnostic, surgical, or other facility or location used for treatment. The computing platform may also include wireless, handheld, mini, and “wearable” computing components and interfaces as are known in the art. Output information from equipment relevant to performing the treatment is integrated with reference databases (which can include search engines) of best demonstrated practices, similar cases, industry guidelines, and procedure and equipment trouble shooting. The system and method of the present invention can also serve as a remote control, as appropriate, for networked or otherwise connected medical equipment and may also provide data that will be captured in the patient record for the treatment performed.

This unique system and method enables the health care provider to immediately access emergency procedures and/or be voice and/or video linked to other institutions and knowledgeable persons for consultation while engaged in the treatment. In addition, diagnostic systems information may be combined with current patient information and analyzed to provide real time guidance and alerts for possible adverse events, and provide references automatically or on demand for managing critical stages of the treatment.

Referring now to FIG. 1, Computer Aided Interactive Medical Management Information And Control System 100 has Health Care Provider 102 treating a Patient 104 in Treatment Suite 106. Treatment Suite 106 may be a doctor's office, an operating suite, a cardiac catheter lab, or any other room, facility, or location used by a health care provider for treating a patient. For example, Health Care Provider 102 may be diagnosing Patient 104 who has come in for a checkup, a cancer screening, or for some other diagnostic procedure. Or, Health Care Provider 102 may be performing a surgical procedure on Patient 104. Patient 104 may be fully awake, sedated, under local anesthetic, or fully anesthetized depending upon the treatment being performed by Health Care Provider 102. One or more Assistant(s) 124 may also be involved in helping Health Care Provider 102 with the treatment. Assistant 124 may be another health care provider as defined above.

At Patient 104's side and at Health Care Provider 102's fingertips during the various treatments performed by Health Care Provider 102 is the computing platform, shown in FIG. 1 as Computer 108, and Monitor 110, which is connected to Computer 108. Monitor 110 may be any type of output interface device including by way of example, but not limited to, holographic display devices, cathode ray tubes (“CRTs”), and any other types of visual display devices, analog or digital. Computer 108 and Monitor 110 may be situated on Mobile Stand 112, or incorporated into Patient Table 114 through attachment means and integral storage spaces beneath the upper surface of Patient Table 114. Or, Computer 108 and Monitor 110 could be suspended from the ceiling, or any combination of the above. Computer 108 may be free standing as shown in FIG. 1, or could be integrated into other existing Treatment Suite 106 equipment computer(s) or medical facility computer system(s). Patient Table 114 may be mobile or stationary. Though only one Monitor 110 and Computer 108 is shown in FIG. 1, there may be one or more Monitor 110's connectable to one or more Computer 108's in a stand alone or a networked configuration as described above.

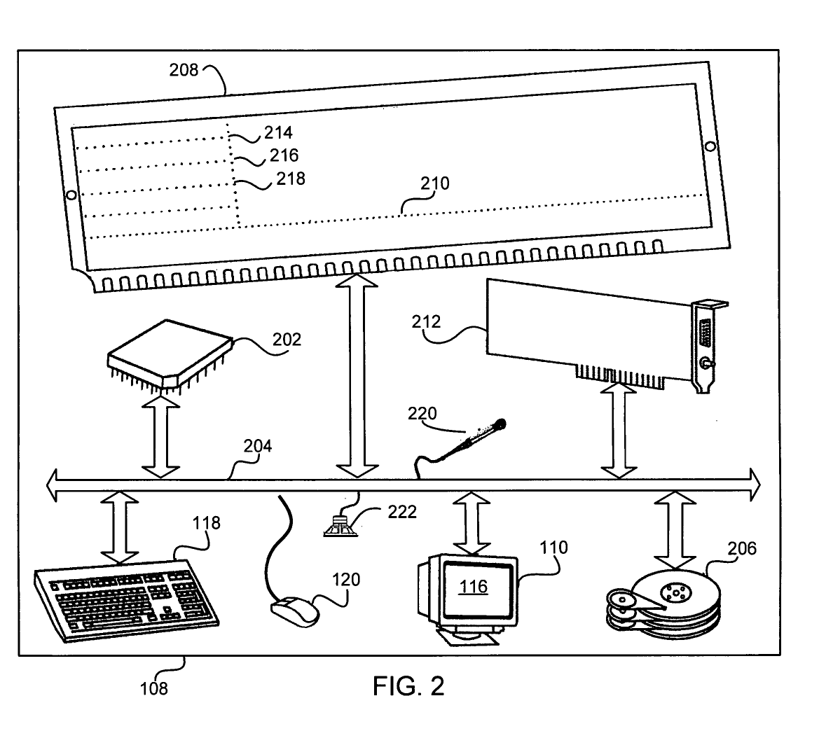

Computer 108 may receive input from Health Care Provider 102 through various input means, including audible commands received in a microphone worn by Health Care Provider 102 in a headset (not shown) connected to Computer 108, or through a microphone integral to or externally connected to Computer 108 (see FIG. 2). Further input may be received from Health Care Provider 102 via touch input through Touch Screen 116 of Monitor 110, key entry through Keyboard 118, and input through Graphical Input Device 120, which may be a mouse, joy stick, or any other type of suitable input device. Computer 108 may output information to Health Care Provider 102 visually through a graphical user interface for display on Monitor 110, audibly through a speaker integral to Computer 108 (see FIG. 2), or through a speaker in a headset (not shown) connected to Computer 108, or through any other suitable output means. Running on Computer 108 is Control Software 216 (see FIG. 2) which controls the input received from Health Care Provider 102 and the output of Computer 108 presented to Health Care Provider 102.

Connectable to Computer 108 may be one or more Medical Device(s) 122 relevant to performing a treatment on Patient 104. Medical Device 122 may be by way of example, but is not limited to, an imaging machine (x-ray, magnetic resonant imaging (MRI), computerized tomography (CT), ultrasound, bone densitometry, coronary angiography, and the like), patient monitor, drug delivery device, and the like. Information may be transmitted from Medical Device 122 to Computer 108 through cabling, infrared transmission, wireless transmission, satellite telemetry, or any other appropriate transmission means. In an embodiment of the invention, Health Care Provider 102 may be able to control the function and operation of Medical Device 122 with the Control Software 216 through one or more of Touch Screen 116, Keyboard 118, Graphical Input Device 120, input mechanisms of a handheld computing device, or audible commands through a microphone in conjunction with speech recognition software. Computer 108 processes the inputs through the Control Software 216 and sends control signals to Medical Device 122. This eliminates the need to have a technician stationed at Medical Device 122 listening to Health Care Provider 102 for operating instructions. For example, an IV pump and drug delivery device could be controlled by Health Care Provider 102 to administer dosages of drugs to Patient 104 during the treatment. Likewise, in a catheter lab, the x-ray machine could be controlled with Touch Screen 116, Keyboard 118, or Graphical Input Device 120, moving the x-ray machine into proper position relative to Patient 104 and activating the imaging function.

Adjacent to Treatment Suite 106 in one embodiment of the invention is Control Room 126. For certain treatments, such as a catheter procedure in Treatment Suite 106, the Assistant(s) 124 may have headsets through which they are feeding information verbally to a Nurse 128 (or some other technician, assistant, or other healthcare provider) that is manning Control Station 130. Control Station 130 may also be receiving data directly from Medical Device 122, such as fluoroscopic images, and Nurse 128 may be periodically recording certain of those images at Control Station 130. The captured images and other data being fed into Control Station 130 may be stored in a patient file in a storage device for Patient 104. The stored information may become part of the patient's record for the treatment being performed by Health Care Provider 102. Nurse 128 may record a drug dosage as it is administered. Nurse 128 may record verbal comments made by Health Care Provider 102 during the treatment. Health Care Provider 102 may have access to the patient record via Computer 108 and a communication link (not shown) to Control Station 130. In another embodiment of the invention, the patient record may reside directly on Computer 108.

Control Station 130 may be in communication with the medical facility equipment and supply system (such as is typically present in a hospital). Thus, if Nurse 128 records, for example, the milligrams of dopamine administered to Patient 104, the equipment and supply system removes that amount of dopamine from its inventory. An order for more dopamine may automatically be placed once a predetermined minimum level of dopamine is reached as a result of consumption. Likewise, Health Care Provider 102 could access the medical facility equipment and supply system through Computer 108 and the communication link and select via Touch Screen 116 a J-hook catheter with a 45 degree angle from the equipment and supply system. Monitor 110 may display a number of different models of J-hook catheters that are available in inventory. Health Care Provider 102 could then select which model he wants and Monitor 110 may display a bar code for a particular J-hook catheter in inventory. The selected J-hook catheter would then be retrieved from inventory by someone and the bar code would be entered into the patient record to identify exactly what J-hook catheter Health Care Provider 102 used. The time during the procedure that the J-hook catheter was used may also be entered. A bar code reader (not shown) connectable to Computer 108 in Treatment Suite 106 may be used to actually read the bar code on the item, update the equipment and supply system inventory, and update the patient's record automatically.

Health Care Provider 102 may access stored data in the patient record for display on Monitor 110, such as a pre-operative x-ray or MRI, and then access a current x-ray or MRI from Medical Device 122. Health Care Provider 102 can compare the two images and then act accordingly. In addition, Health Care Provider 102 can compare earlier images captured from Medical Device 122 during the treatment with a current image captured from Medical Device 122.

An Imaging System 132 may be located in Control Room 126 for producing printed copies of various images from Medical Device 122. Adjacent to Treatment Suite 106 and Control Room 126 is Electrical Room 134 which contains the electrical transformers, controllers, power distribution box, and power filters necessary for the operation of Medical Device 122.

Computer 108 collects information at various points in time, some during the treatment and some from previous sources of information. The information is accumulated and made available to Health Care Provider 102 so that Health Care Provider 102 can call up the information on an interactive basis. For example, Health Care Provider 102 may call up Patient 104's medical history for review. Health Care Provider 102 may call up any of the data that is being collected in real time for review, allowing Health Care Provider 102 to have the most information immediately available at Patient 104's side while performing the treatment on Patient 104. Health Care Provider 102 may utilize the aggregated data from previous procedures to guide performance during the current procedure. Various algorithms built into Control Software 216 (FIG. 2) may provide real time feedback regarding trends, success probabilities, and guidelines to direct or influence actions taken by Health Care Provider 102.

In addition, Health Care Provider 102 may in real time contact Medical Facility 138 over Communication Link 140 and speak to a knowledgeable person regarding the particular treatment Health Care Provider 102 is performing on Patient 104. Medical Facility 138 may be a hospital, a medical institution, a private physician's office, or some other facility having medical professionals with the desired knowledge. Communication Link 140 may be a telephone line, an Internet connection, a WAN or LAN network connection, a wireless connection, or any other suitable communication channel.

For example, Medical Facility 138 could be renowned for emergency room (“ER”) work such that if Patient 104 is a trauma victim and Treatment Suite 106 is an ER room located across town or across the country, and Health Care Provider 102 is not experienced with the particular trauma needing treatment, Health Care Provider 102 can be in live communication with a knowledgeable person at Medical Facility 138. One or more Cameras 136, which may be video or digital cameras, may relay to the Medical Facility 138 via Communication Link 140 the scene in Treatment Suite 106 so that the knowledgeable person can actually see what Health Care Provider 102 is seeing. Computer 108 may also transfer some or all of the data and images collected regarding the patient and the course of the treatment to date. The knowledgeable person at Medical Facility 138 may refer Health Care Provider 102 to another leading knowledgeable person at another medical facility who is more experienced with the particular trauma situation at hand, and/or link the second knowledgeable person in real time to Health Care Provider 102 through a voice connection, video connection, or Internet connection and the like.

Health Care Provider 102 may also in real time through the Control Software 216 running on Computer 108 contact Medical Society 142 over Communication Link 144. In addition to a knowledgeable person, Medical Society 142 may maintain a database of best practices for the particular treatment Health Care Provider 102 is attempting to perform. The database may contain guidelines, procedures, or other didactic material on how to perform the treatment in question. For example, Medical Society 142 database may have information stored indicating that eight out of ten patients who have a list of five symptoms or combinations of symptoms should have a certain treatment performed.

Thus, Health Care Provider 102 may retrieve historical information on the particular treatment he is about to perform, and receive information regarding typical complications. More relevantly, based on data collected by and input into Computer Aided Interactive Medical Management Information And Control System 100, Health Care Provider 102 may receive information on what complications could be likely with the patient in hand and what to watch out for. The information may relate to a particular patient or to many patients that have the general condition of Patient 104.

Health Care Provider 102 may in real time contact Medical Manufacturer 146 over Communication Link 148 and speak to a knowledgeable person regarding the medical device or instrument Health Care Provider 102 is using to perform the treatment on Patient 104. Communication Link 148 may be a telephone line, an Internet connection, a WAN or LAN network connection, a wireless connection, or any other suitable communication channel.

Health Care Provider 102 may also access a database through Communication Link 148 made available by Medical Manufacturer 146. The database may have product information on the medical device regarding instructions for its use. This is in addition to any normal training Health Care Provider 102 may have received from a sales representative of Medical Manufacturer 146 or a mentor familiar with the use of the medical device. Health Care Provider 102 may access any tips and tricks that were learned during the investigational phase and the clinical trials for the medical device that Medical Manufacturer 146 makes available through the database.

Computer Aided Interactive Medical Management Information And Control System 100 may also serve as a platform by which medical societies or governmental agencies, such as the Federal Drug Administration (FDA), mandate new procedures and/or devices when used for the first time by Health Care Provider 102. In addition, all adverse events from the clinical trials and actual life of a medical device or treatment may be imbedded and made available for replay through Computer Aided Interactive Medical Management Information And Control System 100.

Health Care Provider 102 may also access information from a Simulation Training System 150 through Communication Link 152. Communication Link 152 may be a telephone line, an Internet connection, a WAN or LAN network connection, a wireless connection, or any other suitable communication channel. Simulation Training System 150 may be located adjacent to Treatment Suite 106 or across the country. Simulation Training System 150 helps teach doctors the fundamentals of how to diagnose what is wrong with a simulated patient and then how to go about treating the simulated patient. Through simulation the doctor is exposed to the various scenarios that demonstrate what can go wrong, whether caused by the doctor's actions, or caused by random unrelated events. Through simulation training a doctor is able to practice the really rare complications that come along and learn what do. Doctors often only have seconds to decide what to do, and simulation training helps them to know the right thing to do in a real situation. Simulation Training System 150 may gather and store a large amount of data and information on how doctors and nurses and technicians perform various treatments on patients and how they respond to adverse events. The simulation helps demonstrate what is recommended, and what does not work, without jeopardizing the life of a real patient. Health Care Provider 102 may recall performing a simulated treatment with Simulation Training System 150 when faced with a similar treatment that Health Care Provider 102 is now performing. Health Care Provider 102 can call up that simulation and review what happened for application to the case at hand.

Also, Health Care Provider 102 may also choose to first run a real time simulation of the procedure to be performed on Patient 104 before actually performing the real procedure. Health Care Provider 102 may search through the library of stored simulations and select the procedure about to be performed and run the simulation for the procedure from model data stored in Simulation Training System 150. Health Care Provider 102 may also supply Simulation Training System 150 with current patient data from Medical Device 122 and/or patient record data via Communication Link 152 for running the selected simulation to achieve even more realism.

FIG. 2 shows a schematic/block diagram of the computing platform of FIG. 1 in an embodiment of the present invention. Referring now to FIG. 2, Computer 108, which may also be multiple linked or networked computers or computer processors in other embodiments of the invention, contains a Processing Element 202. The Processing Element 202 communicates to other elements of Computer 108 over a System Bus 204. Keyboard 118 allows Health Care Provider 102 to input information into Computer 108, and a Monitor 110 allows Computer 108 to output information to Health Care Provider 102. Monitor 110 may be any type of input/output interface device including by way of example, but not limited to, virtual reality tools, haptic interface devices, wearable gloves, holographic display devices, and any other type of visual display device. Monitor 110 has Touch Screen 116, allowing Health Care Provider 102 to input information into Computer 108 through this mode. Graphical Input Device 120, which may be a mouse, joy stick, or other type of suitable input device, is also used by Health Care Provider 102 to input information. A Storage Device 206 is used to store data and programs within Computer 108. A memory 208, also connected to System Bus 204, contains an Operating System 210, Graphic User Interface 214, and Control Software 216, which may comprise several modules, including Voice Recognition Module 218. A Communications Interface 212 is also connected to System Bus 204. Communications Interface 212 may have one or more serial ports, parallel ports, infrared ports, and the like. Connectable through Communications Interface 212 may be an external printer or scanner and Camera 136, as well as a communication link to external sources, such as a computer network (LAN or WAN), to the Internet, a wireless connection, or to any other appropriate communication channel (not shown in FIG. 2). A Microphone 220 and a Speaker 222 are also connected to System Bus 204. Microphone 220 may be integral to or externally connected to Computer 108. Many other types of input and output devices may be utilized in the present invention as one skilled in the art will recognize, and the invention is not limited to the specific embodiments shown.

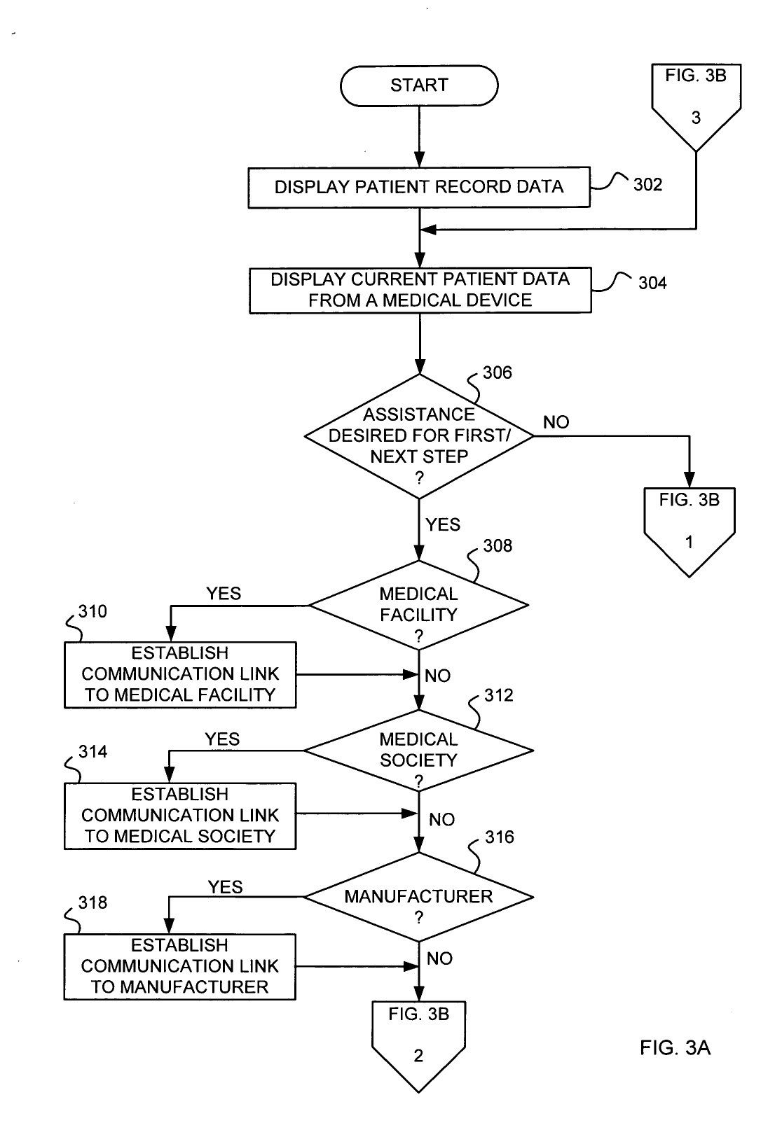

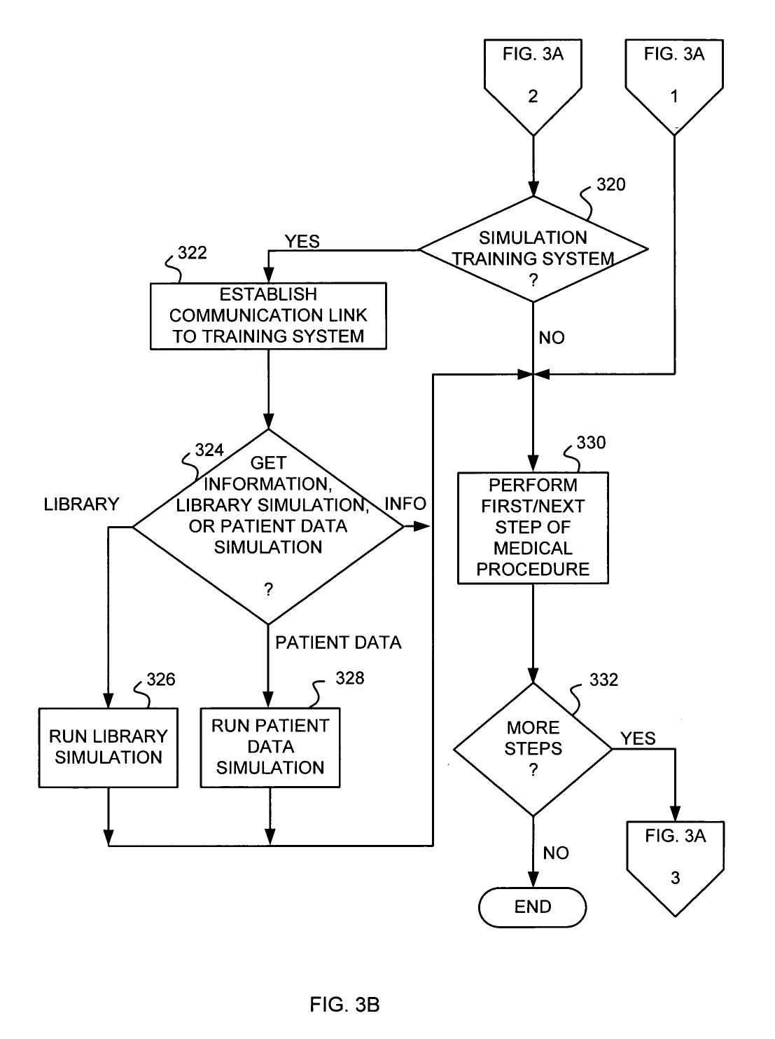

FIGS. 3A and 3B show a block flow diagram of an embodiment of a computer aided interactive medical management information and control method for assessing, diagnosing, planning, and/or performing treatment on a patient by a health care provider of the present invention. Referring now to FIGS. 3A and 3B, Health Care Provider 102 is about to begin performing a treatment on Patient 104 in Treatment Suite 106. In step 302 patient record data is displayed on Monitor 110. The patient record data may be retrieved from Control Station 130, or from Storage Device 206. In step 304 current patient data from Medical Device 122 is also displayed on Monitor 110 in a split screen fashion, or on an additional Monitor 110. Medical Device 122 may be, but is not limited to, an imaging machine (x-ray, magnetic resonant imaging (MRI), computerized tomography (CT), ultrasound, bone densitometry, coronary angiography, etc.), patient monitor, drug delivery device, and the like.

Current patient data from Medical Device 122 may be continuously or periodically updated on Monitor 110 during the course of the treatment, or updated after a manipulation of Medical Device 122. Control Software 216 and Graphic User Interface 214 determine how the current patient data and patient record data are displayed visually or output audibly. Health Care Provider 102 can call up the patient data and the patient record data interactively through any of the various input mechanisms to aid Health Care Provider 102 in performing the treatment. In addition, various algorithms built into Control Software 216 (FIG. 2) may provide real time feedback displayable on Monitor 110 or audibly displayed through Speaker 222 regarding trends, success probabilities, and guidelines to direct or influence actions taken by Health Care Provider 102 in performing the treatment.

In step 306 Health Care Provider 102 determines if any external assistance in performing the first step of the treatment is desired. If not, control flows to step 330 (FIG. 3B) and Health Care Provider 102 performs the first step of the treatment. In step 332 Health Care Provider 102 determines if there are more steps in the treatment to be performed. If not, the method of the present invention ends. If more steps are to be performed, then control returns to step 304 (FIG. 3A).

If in step 306 Health Care Provider 102 determines that external assistance is desired from an external source in performing the first, or next step, of the treatment, then Health Care Provider 102 determines in step 308 if the best external assistance for performing the current step in the treatment can be obtained from a medical facility. If yes, then Health Care Provider 102, utilizing any of the various input means to Computer 108, such as Touch Screen 116, Keyboard 118, Graphical Input Device 120, or voice commands utilizing Microphone 220 and Voice Recognition Module 218 which receives, processes, and translates voice commands into computer instructions, establishes a Communication Link 140 with Medical Facility 138 in step 310. Communication Link 140 may be a telephone line for a voice call, an Internet connection, a WAN or LAN network connection, a wireless connection, satellite link, or any other suitable communication channel. A video feed from Camera 136 may be sent via Communication Link 140 to the Medical Facility 138 so a knowledgeable person (such as another health care provider, specialist, consultant, or the like) in communication with Health Care Provider 102 can see what Health Care Provider 102 is seeing and/or doing. Health Care Provider 102 may have verbal conversation with the knowledgeable person at Medical Facility 138 until Health Care Provider 102 has the information needed to perform the current step of the treatment. Besides a knowledgeable person, external assistance may also be obtained from an intelligent data source at Medical Facility 138, such as a neural network, knowledge database, and the like. However, Health Care Provider 102 may determine that further external assistance is needed, in which case control flows to step 312.

If in step 308 Health Care Provider 102 determines that external assistance from Medical Facility 138 is not needed, but that further external assistance is needed, then Health Care Provider 102 determines in step 312 if the best external assistance for performing the current step in the treatment can be obtained from a medical society. If yes, then Health Care Provider 102, utilizing any of the various input means to Computer 108 enumerated above, establishes a Communication Link 144 with Medical Society 142 in step 314. Communication Link 144 may be a telephone line for a voice call, an Internet connection, a WAN or LAN network connection, a wireless connection, satellite link, or any other suitable communication channel. Typically, Medical Society 142 will maintain intelligent data sources, such as individuals, databases, or neural networks containing guidelines, procedures, or other didactic material on how to perform the treatment, and hopefully the particular step in question. Health Care Provider 102 may query the intelligent data source until Health Care Provider 102 has the information needed to perform the current step of the treatment. However, Health Care Provider 102 may determine that further external assistance is needed, in which case control flows to step 316.

If in step 312 Health Care Provider 102 determines that external assistance from Medical Society 142 is not needed, but that further external assistance is needed, then Health Care Provider 102 determines in step 316 if the best external assistance for performing the current step in the treatment can be obtained from a medical manufacturer of a medical device or instrument that Health Care Provider 102 needs to use in performing the treatment, such as Medical Device 122. If yes, then Health Care Provider 102, utilizing any of the various input means to Computer 108 enumerated above, establishes a Communication Link 148 with Medical Manufacturer 146 in step 318. Communication Link 148 may be a telephone line for a voice call, an Internet connection, a WAN or LAN network connection, a wireless connection, satellite link, or any other suitable communication channel. Health Care Provider 102 may speak to a knowledgeable person regarding the use and operation of the medical device or instrument to get the external assistance needed. In addition to individuals, Medical Manufacturer 146 may maintain other intelligent data sources such as neural networks, knowledge databases, and the like containing product information on the medical device or instrument regarding instructions for its use to perform the particular step of the treatment in question. Health Care Provider 102 may query the intelligent data source until Health Care Provider 102 has the information needed to perform the current step of the treatment. However, Health Care Provider 102 may determine that further external assistance is needed, in which case control flows to step 320.

If in step 316 Health Care Provider 102 determines that external assistance from Medical Manufacturer 146 is not needed, but that further external assistance is needed, then Health Care Provider 102 determines in step 320 if the best external assistance for performing the current step in the treatment can be obtained from a simulation training system. If yes, then Health Care Provider 102, utilizing any of the various input means to Computer 108 enumerated above, establishes a Communication Link 152 with Simulation Training System 150 in step 322. Communication Link 152 may be a telephone line for a voice call, an Internet connection, a WAN or LAN network connection, a wireless connection, satellite link, or any other suitable communication channel. In step 324 Health Care Provider 102 determines what type of assistance is desired. Health Care Provider 102 may choose to access a database of Simulation Training System 150 to simply retrieve information stored there about the treatment, or a similar treatment, that Health Care Provider 102 is now performing or about to perform. Once the information is retrieved and reviewed, control then flows to step 330.

Health Care Provider 102 may choose in step 324 to access a database of Simulation Training System 150 containing a library of simulations and select the treatment, or similar treatment, that Health Care Provider 102 is now performing or about to perform. Health Care Provider 102 can then run the simulation in step 326, which may be displayed on Monitor 110 via Communication Link 152, based on model data or other patient data to gain the information needed to perform the current step of the treatment. After the simulation has been run, control then flows to step 330.

Finally, Health Care Provider 102 may choose to run a simulation for the treatment, or similar treatment, from the library of simulations and supply Simulation Training System 150 with current patient data from Medical Device 122 and/or patient record data via Communication Link 152 instead of using the model data or other patient data. In step 328 Simulation Training System 150 receives the current patient data and/or patient record data and incorporates the data into the simulation, and returns the simulation via Communication Link 152 for display on Monitor 110. After the simulation has been run, control then flows to step 330.

In step 330, Health Care Provider 102 performs the first step, or next step, of the treatment which may also involve the manipulation of Medical Device 122 with the Control Software 216 through one or more of Touch Screen 116, Keyboard 118, Graphical Input Device 120, through a handheld computing device, or audible commands through a microphone. Health Care Provider 102 may manipulate Medical Device 122 at any time during the treatment. In step 332 Health Care Provider 102 determines if there are more steps to be performed in the treatment. If there are no more steps to be performed in the treatment, then the method of the present invention ends. If there are more steps to be performed, control returns to step 304 (FIG. 3A), where current patient data from Medical Device 122 may be updated for display on Monitor 110. Steps 304 through 332 are repeated until the treatment is completed. Or, if at any time during the treatment a problem develops, Health Care Provider 102 may repeat steps 304 through 332 to gain external assistance in dealing with the problem.

Having described the present invention, it will be understood by those skilled in the art that many changes in construction and circuitry and widely differing embodiments and applications of the invention will suggest themselves without departing from the scope of the present invention.

What is claimed is:

1. A computer aided interactive medical management information and control method for assessing, diagnosing, planning, and/or performing a treatment on a patient by a health care provider, the method comprising the steps of:
(a) displaying on at least one visual display device a patient data of the patient from at least one medical device utilized in the treatment;
(b) determining by the health care provider if external assistance is desired in performing a first step of the treatment on the patient;
(c) when said external assistance is desired for performing said first step of the treatment, determining by the health care provider at least one external source to access to obtain said external assistance;
(d) establishing a communication link with said at least one external source;
(e) acquiring by the health care provider said external assistance from said at least one external source through said communication link; and
(f) performing by the health care provider said first step of the treatment in light of said external assistance.

2. A method according to claim 1 further comprising the steps of:
(g) repeating steps (a) through (f) for a next step of the treatment; and
(h) repeating step (g) until all of the steps of the treatment are performed.

3. A method according to claim 1 further comprising:
displaying on said at least one visual display device a patient record data of the patient from at least one storage device.

4. A method according to claim 3 further comprising:
calling up interactively by the health care provider said patient data from said at least one medical device and said patient record data from said at least one storage device to assist the health care provider in performing the treatment.

5. A method according to claim 1 further comprising the steps of:
manipulating said at least one medical device through input from the health care provider received in a computing platform running control software, said computing platform connectable to said at least one medical device; and
displaying updated patient data of the patient from said manipulation of said at least one medical device on said at least one visual display device.

6. A method according to claim 5 further comprising:
providing real time feedback to the health care provider through said control software to guide the health care provider in performing the treatment.

7. A method according to claim 6 wherein said real time feedback is displayed visually on said at least one visual display device.

8. A method according to claim 6 wherein said real time feedback is displayed audibly through a speaker.

9. A method according to claim 1 wherein said communication link is at least a one of a telephone line for a voice call, an Internet connection, a WAN network connection, a LAN network connection, a wireless connection, and a satellite connection.

10. A method according to claim 1 wherein said at least one external source is at least one intelligent data source from a one of a medical facility, a medical society, a medical manufacturer, and a simulation training system.

11. A method according to claim 10 further comprising the steps of:
accessing via said communication link a simulation of the treatment to be performed from said simulation training system; and
reviewing said simulation of the treatment to be performed on said at least one visual display device.

12. A method according to claim 10 further comprising the steps of:
accessing via said communication link a simulation of the treatment to be performed from a library of simulations based on model data or other patient data in said simulation training system; and
running said simulation of the treatment via said communication link and output on said at least one visual display device.

13. A method according to claim 10 further comprising the steps of:
accessing via said communication link a simulation of the treatment to be performed from said simulation training system;
supplying said simulation training system with a current patient data of the patient from said at least one medical device via said communication link;
incorporating said current patient data of the patient into said simulation of the treatment by said simulation training system; and
running said simulation of the treatment with said current patient data via said communication link and output on said at least one visual display device.

14. A method according to claim 10 wherein said at least one intelligent data source is at least a one of a knowledgeable person, a neural network, and a knowledge database.

15. A method according to claim 14 further comprising:
sending from at least one camera a video feed of the health care provider performing the treatment over said communication link to said knowledgeable person to aid said knowledgeable person in providing said external assistance to the health care provider.

16. A method according to claim 10 further comprising:
querying by the health care provider over said communication link said intelligent data source maintained by said one of said medical facility, said medical society, said medical manufacturer, and said simulation training system to obtain said external assistance.

17. A computer aided interactive management information and control system for assessing, diagnosing, planning, and/or performing a treatment on a patient by a health care provider, the system comprising:
a computing platform, said computing platform further comprising:
a control software running on said computing platform;
at least one storage device connectable to said computing platform for storing said control software;
at least one input device connectable to said computing platform for enabling the health care provider to input commands to said computing platform; and
a communications interface for establishing a communication link to at least one external source;
at least one medical device connectable to said computing platform, wherein said at least one medical device is utilized in the treatment performed by the health care provider; and
at least one output device connectable to said computing platform for outputting a patient data of the patient from said at least one medical device;
wherein when external assistance is desired by the health care provider in performing any of the steps of the treatment, the health care provider obtains said external assistance from said at least one external source through said communication link.

18. The system according to claim 17 wherein said at least one input device is a one of a microphone, a touch screen, a keyboard, and a graphical input device.

19. The system according to claim 17 wherein said at least one medical device is a one of an imaging machine, a patient monitor, and a drug delivery device.

20. The system according to claim 17 wherein said at least one storage device stores a patient data record of the patient and said at least one output device outputs said patient data record stored on said at least one storage device.

21. The system according to claim 17 further comprising:
at least one camera connectable to said computing platform for sending a video feed of the health care provider performing the treatment over said communication link to a knowledgeable person at a one of a medical facility, a medical society, a medical manufacturer, and a simulation training system to aid said knowledgeable person in providing said external assistance to the health care provider.

22. The system according to claim 21 wherein said simulation training system further comprises:
a library of simulations, wherein the health care provider selects at least one of said simulations in said library of the treatment to be performed on the patient, wherein said at least one of said simulations of the treatment is sent via said communication link for display on said at least one output device.

23. The system according to claim 21 wherein said simulation training system further comprises:
a simulation of the treatment to be performed on the patient, wherein the health care provider sends a current patient data of the patient from said at least one medical device via said communication link and said simulation training system incorporates said current patient data of the patient into said simulation of the treatment to be performed, and said simulation of the treatment to be performed is sent via said communication link for display on said at least one output device.

24. The system according to claim 17 further comprising:
at least one intelligent data source maintained by said one of said medical facility, said medical society, said medical manufacturer, and said simulation training system wherein the health care provider queries said at least one intelligent data source over said communication link to obtain said external assistance.

25. The system according to claim 17 further comprising:
a control station connectable to said computing platform having at least one storage device, wherein said control station receives and stores data in said patient record data from said at least one medical device.

26. The system according to claim 17 wherein said computer further comprises:
a voice recognition module running in a memory of said computing platform for receiving, processing, and translating a plurality of voice commands from the health care provider into computer instructions.
